(19) United States
(12) Patent Application Publication
(10) Pub. No.: US 2024/0394438 A1
(43) Pub. Date: Nov. 28, 2024

(54) SIMULATION PROVIDING DEVICE AND SIMULATION PROVIDING METHOD

(71) Applicant: LG INNOTEK CO., LTD., Seoul (KR)

(72) Inventors: Seung Hoon LEE, Seoul (KR); Jae Hyun KIM, Seoul (KR)

(21) Appl. No.: 18/692,066

(22) PCT Filed: Sep. 14, 2022
(86) PCT No.: PCT/KR2022/013724

§ 371 Date: Mar. 14, 2024

(30) Foreign Application Priority Data
Sep. 14, 2021 (KR) 10-2021-0122643

(51) Int. Cl. G06F 30/20

(52) U.S. Cl. CPC G06F 30/20

(57) ABSTRACT

A simulation providing method according to an embodiment of the present invention comprises the steps of: receiving simulation module selection information and input information from a user terminal; and performing a simulation using the received simulation module selection information and the input information, and transmitting a result of the simulation to the user terminal, wherein the input information includes at least one of appearance information, physical property information, and analysis condition information.

### TECHNICAL FIELD

The present invention relates to a simulation providing device and a simulation providing method, and more specifically, to a simulation providing device and a simulation providing method that can perform a simulation without help from an expert.

### BACKGROUND ART

When performing design for various products such as motors and boards, simulation is performed to test the designed products. When performing a simulation, the help of some experts who have relevant expertise and can use specialized simulation tools is needed. There are problems that arise in cases where simulation work is concentrated on experts and it is difficult to simulate quickly, and tasks such as customer response and product development cannot be responded to in a timely manner.

There is a need to develop technology that allows non-simulation experts without expert knowledge to perform simulations without help from an expert.

### DETAILED DESCRIPTION OF THE INVENTION

### Technical Subject

The technical problem to be solved by the present invention is to provide a simulation providing device and a simulation providing method that can perform simulation without help from an expert.

### Technical Solution

In order to solve the above technical challenges, a simulation providing method according to an embodiment of the present invention comprises the steps of: receiving simulation module selection information and input information from a user terminal; and performing a simulation using the received simulation module selection information and the input information, and transmitting a simulation performance result the to the user terminal, wherein the input information includes at least one among appearance information, physical property information, and analysis condition information.

In addition, the appearance information may include at least one of selection information for selecting one of the exterior dimensions of the corresponding object to be simulated, drawing data, or appearance information stored in the storage unit.

In addition, the physical property information may include at least one among the physical property data of the object to be simulated, selection information for selecting one of the physical property information stored in the storage unit, or correction information for selecting and modifying one of the physical property information stored in the storage unit.

In addition, the analysis condition information may include at least one among simulation environment information, boundary conditions, excitation conditions, and parameter data.

In addition, the step of receiving the simulation module selection information and input information may include the steps of: receiving the simulation module selection information from the user terminal; requesting input information required for a simulation module selected according to the received simulation module selection information to perform simulation from the user terminal; and receiving input information required to perform the simulation from the user terminal.

In addition, the input information required to perform the simulation may be preset for each simulation module or may be set by a manager.

In addition, the step of transmitting the simulation performance results to the user terminal may include the steps of: selecting at least one simulation module among a plurality of simulations according to the received simulation module selection information; performing a simulation using the selected simulation module and the input information; and transmitting the simulation performance results to the user terminal.

In addition, the step of selecting the simulation module selects a first simulation module according to the received simulation module selection information, or may select one or more second simulation modules set as simulation modules being linked to the selected first simulation module together with the first simulation module

In addition, the second simulation module is a simulation module that uses the results of the first simulation module, or may be a simulation module that performs simulation simultaneously with the first simulation.

In addition, the input information May include at least one among individual input information for the first simulation module, individual input information for the second simulation module, and common input information for the first simulation module and the second simulation module.

In addition, the step of performing the simulation may include the steps of: simplifying appearance information according to the drawing data when the appearance information included in the above input information includes drawing data; or drawing the appearance dimensions when the appearance information included in the above input information includes appearance values.

In addition, the expected end time of the simulation can be calculated and transmitted to the user terminal by using the received simulation module selection information and the currently working task.

In addition, when receiving multiple simulation requests from multiple user terminals or receiving multiple simulation requests from one user terminal, the work schedule of the task to perform simulation according to the plurality of simulation requests can be set depending on the priority of resource allocation.

In addition, it may include the steps of: receiving at least one of a simulation module program, simulation module linkage setting information, physical property information, parameter information, license, and user authority management information from a manager terminal; and storing information received from the manager terminal in a storage unit.

In order to solve the above technical problem, a simulation providing device according to an embodiment of the present invention comprises: a communication unit that receives simulation module selection information and input information from a user terminal and transmits simulation performance results to the user terminal; and a processing unit that performs simulation using the received simulation module selection information and the input information, wherein the input information includes at least one among external information, physical property information, and analysis condition information.

In addition, the communication unit may receive at least one among a simulation module program, simulation module linkage setting information, physical property information, parameter information, license, or user authority management information from the manager terminal.

In addition, it may include a storage unit that stores a plurality of simulation modules, simulation module linkage setting information, simulation performance results, appearance information, physical property information, parameter information, license, and user authority management information.

In addition, the processing unit: selects at least one simulation module among a plurality of simulations according to the received simulation module selection information; performs a simulation using the selected simulation module and the input information; selects a first simulation module according to the received simulation module selection information in selecting the simulation module; or may select one or more second simulation modules set as a simulation module being linked to the selected first simulation module can be selected together with the first simulation module.

In addition, the second simulation module is a simulation module that uses the results of the first simulation module, or is a simulation module that performs simulation simultaneously with the first simulation, and the input information may include at least one among individual input information for the first simulation module, individual input information for the second simulation module, and common input information for the first simulation module and the second simulation module.

In addition, the communication unit may include an interface that receives the simulation module selection information or the input information, or outputs the simulation performance results.

### Advantageous Effects

According to embodiments of the present invention, by using a simulation system built on a server, simulation can be performed by connecting to the server when required without the need to separately install a professional simulation tool, and the needed simulation can be performed even if you have no simulation-related knowledge. Therefore, simulation results can be obtained in a timely manner without having to consider the schedule of a simulation expert.

In addition, the licenses required to use the simulation tool can be efficiently managed; and simulation results, physical property information, and the like are stored in a database so that they can be easily reused in the future.

Furthermore, one simulation module can be used alone, or multiple modules can be used to perform complex simulations by exchanging input and output and linking together, and managers can efficiently perform maintenance upgrading simulation modules and the like.

### BRIEF DESCRIPTION OF DRAWINGS

FIG. 1 is a block diagram of a simulation providing device according to an embodiment of the present invention.

FIGS. 2 and 3 are block diagrams of a simulation providing device according to an embodiment of the present invention.

FIGS. 4 to 9 are diagrams for explaining a simulation providing process of a simulation providing device according to an embodiment of the present invention.

FIG. 10 is a flowchart of a method for providing simulation according to an embodiment of the present invention.

FIGS. 11 to 14 are flowcharts of a method for providing simulation according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

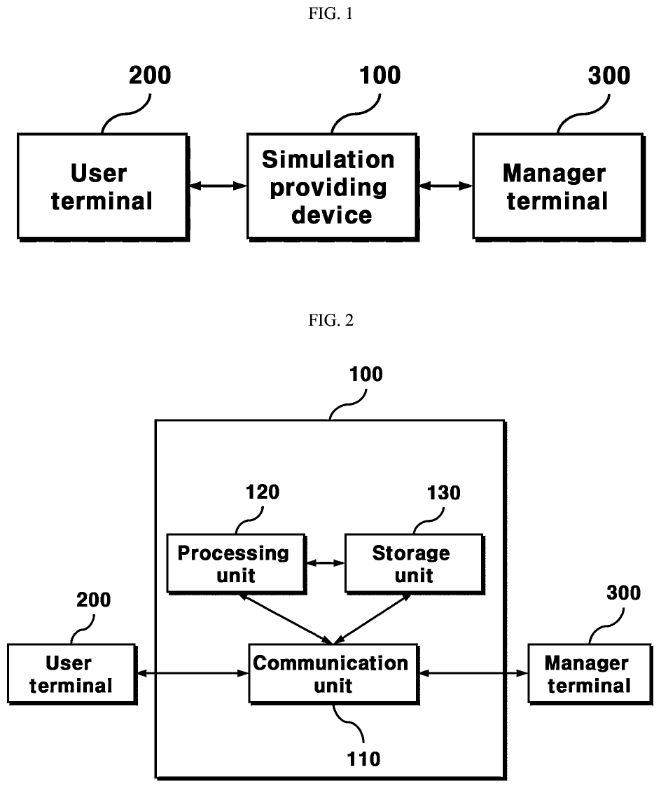

FIG. 1 is a block diagram of a simulation providing device according to an embodiment of the present invention.

The simulation providing device 100 according to an embodiment of the present invention outputs the results of performing a simulation according to a simulation request from the user terminal 200. The user selects the type of simulation to perform through the user terminal 200 and inputs input information required for the simulation providing device 100 to perform the simulation. The simulation providing device 100 performs a simulation using a simulation module selected through the user terminal 200 among a plurality of simulation modules and provides simulation performance results. The manager of the simulation providing device 100 can manage the simulation providing device 100 and perform upgrades and the like through the manager terminal 300.

Here, the simulation providing device 100 may be a simulation providing server. The user terminal 200 can connect to the server, which is the simulation providing device 100, through wired or wireless communication and perform a simulation. By using the simulation provided on the server, simulation can be performed without a simulation tool. In addition, simulation can be performed without specialized knowledge for performing simulation using the settings and previous data of the manager terminal 300.

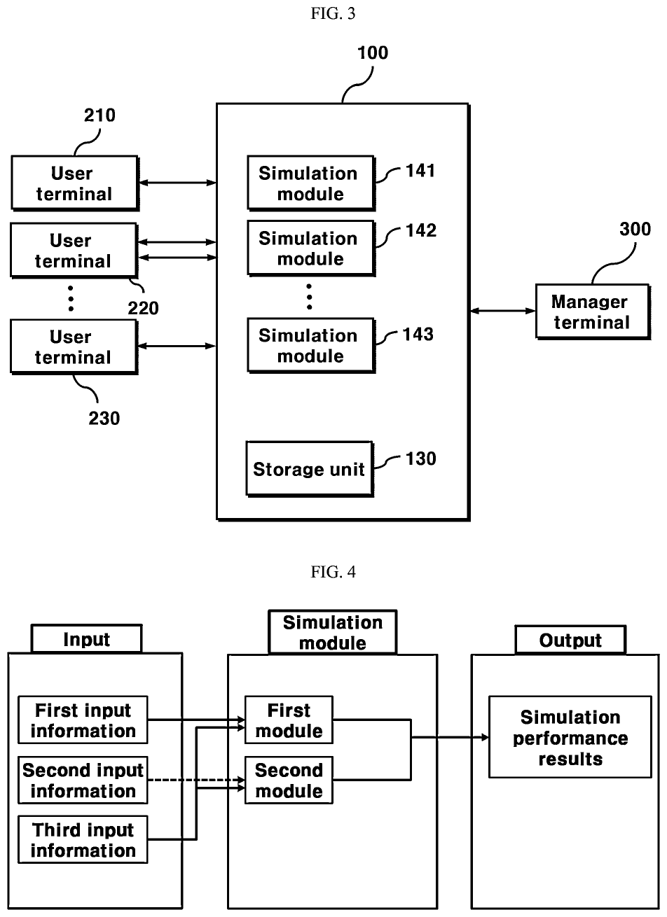

In order to provide a simulation to the user terminal 200, the simulation providing device 100 according to an embodiment of the present invention comprises a communication unit 110 and a processing unit 120, as shown in FIG. 2, and may include a storage unit 130. The simulation providing device 100 according to an embodiment of the present invention may include a plurality of simulation modules 141 to 143, as shown in FIG. 3. The plurality of simulation modules may be simulation modules different from one another. For example, it may include a dynamics analysis simulation module, an electromagnetic analysis simulation module, and the like. Or, it may include multiple simulation modules of the same type. In the case of a widely used simulation module, simulation can be performed simultaneously by including multiple simulation modules rather than one simulation module due to license or resource reasons. Or, a plurality of simulation modules required to perform one simulation type may be set as one module.

The communication unit 110 receives simulation module selection information and input information from the user terminal and transmits simulation performance results to the user terminal.

More specifically, the communication unit 110 receives simulation module selection information and input information from the user terminal 200. Here, the simulation module selection information may include the type of simulation to perform the simulation. The simulation module selection information includes information specifying one simulation module among the simulation modules stored in the simulation providing device 100, or may include information about the type of simulation performed using a plurality of simulation modules. For example, it includes information about a specific simulation module, such as a dynamics analysis simulation module or an electromagnetic analysis simulation module, or it may include information about the type of simulation, such as a motor vibration noise simulation. At this time, in order to perform motor vibration noise simulation, both a dynamics analysis simulation module and an electromagnetic analysis simulation module are required. In addition, it may include information required to select one or more simulation modules among the simulation modules stored in the simulation providing device 100.

Input information is information required for the simulation providing device 100 to perform a simulation, and may refer to information that makes it difficult to perform a simulation when it is not inputted from the user terminal 200. Input information may include at least one among appearance information, physical property information, and analysis condition information.

The appearance information may include at least one of selection information for selecting one of the exterior dimensions of the object to be simulated, drawing data, or appearance information stored in the storage unit. In order to perform simulation, the appearance, that is, shape information, of the corresponding object for which simulation is to be performed is required. The appearance information may be inputted from the user terminal 200 on the appearance dimensions of the corresponding object on which simulation is to be performed. For example, in the case of a substrate, dimensions including width, length, height, and the like may be inputted. It may also include the number of layers of the substrate, and the like. Or, drawing data modeling the corresponding object may be included without receiving dimensions as appearance information. It may be 2D or 3D drawing data. In the case of 2D drawing data, it may be data that includes views of six side surfaces such as floor plans and front views so that three-dimensional information can be obtained. Or, appearance information selection information for selecting appearance information stored in the simulation providing device 100 may be inputted. At this time, the appearance information stored in the simulation providing device 100 includes appearance information stored by size according to the type of corresponding object, or may include appearance information applied to a previously performed simulation. For example, when performing a project, various simulations can be performed on the corresponding object at each project stage, and the appearance information simulated in the previous stage can be selected to perform simulation in the next stage for the same object.

The physical property information may include at least one of the physical property data of the object to be simulated, selection information for selecting one of the physical property information stored in the storage unit, or correction information for selecting and modifying one of the physical property information stored in the storage unit. The physical property information is the physical properties of the corresponding object, and varies depending on the material of the corresponding object, and the simulation results also vary accordingly, so physical property information is required. At this time, physical property information such as electrical conductivity can be directly inputted from the user terminal 200. Or, the material type of the target object can be inputted. At this time, physical property information set according to the material type can be inputted as the physical property information of the corresponding object. Or, selection information to select one of the physical property information stored in the storage unit is inputted, or after selecting one of the physical property information stored in the storage unit, reference property information is provided so that only the property information to be modified is inputted with only correction information. When performing a simulation on one object within one project, pre-stored physical property information can be directly selected by selecting the corresponding object.

The analysis condition information may include at least one among simulation environment information, boundary conditions, excitation conditions, and parameter data. Since simulation is intended to view motion simulation in the environment in which the target object operates, condition information for analyzing the simulation is required. One among simulation environment information, boundary conditions, excitation conditions, and parameter data may be included as analysis condition information. At this time, the simulation environment information may include external temperature, and the like. The boundary conditions may include boundary conditions for the space where the simulation is performed, and the excitation conditions may include conditions for the corresponding object to perform a specific action, and the like. In addition, it may include parameter data applied to formulas required to perform simulation. The analysis condition information can also be inputted directly, or one of the example analysis condition information may be inputted or modified, and previous data can also be used when performing simulation on the same object.

In receiving the simulation module selection information and input information, first receive the simulation module selection information from the user terminal 200, and input information required for the simulation module selected according to the received simulation module selection information to perform simulation can be requested from the user terminal 200. The simulation module selected according to the received simulation module selection information may request the user terminal 200 for input information required to perform the simulation. That is, when simulation module selection information is inputted from the user terminal 200, the type of data required to perform the simulation is read, the data can be requested from the user terminal 200 as input information. At this time, required data other than the data stored in the storage unit 130 of the simulation providing device 100 may be requested as input information from the user terminal 200. For example, inputting of the width, length, and height may be requested. Afterwards, input information required to perform the simulation may be received from the user terminal 200.

Input information required to perform the simulation may be preset for each simulation module or may be set by a manager. The required input information may be different for each simulation module, and the required input information is set, so when the corresponding simulation module is selected, the corresponding input information can be requested. Or, the type of input information may be set by the manager, or may be set to use physical property information or analysis condition information entered by the manager as input information.

It may include an interface that receives the simulation module selection information or the input information. In addition to receiving simulation module selection information or input information through the user terminal 200, simulation module selection information or input information can be inputted through the interface. The interface is a user interface (UI), which may be a graphical user interface (GUI). A graphical user interface is an interface that receives or outputs information using graphic elements displayed on a display. The user can input simulation module selection information or input information through the interface of the simulation providing device.

The processing unit 120 performs simulation using the received simulation module selection information and the input information.

More specifically, simulation is performed using simulation module selection information and input information received from the user terminal 200. The processing unit 120 selects a simulation module to perform simulation from simulation module selection information and performs simulation using input information.

To perform a simulation, the processing unit 120 selects at least one or more simulation modules among a plurality of simulations according to the received simulation module selection information. The simulation providing device 100 includes a plurality of simulation modules stored by a manager. The simulation module may be a program that performs simulation using a simulation tool, or may include instructions executed by the processing unit 120.

The processing unit 120 selects a simulation module to perform simulation among a plurality of simulations according to simulation module selection information. As previously explained, when the simulation module selection information assigns a specific simulation module, the corresponding simulation module is selected, and the simulation module selection information assigns a simulation type, all simulation modules required to perform the simulation may be included.

Or, the first simulation module is selected according to the received simulation module selection information, or one or more second simulation modules set as simulation modules linked to the selected first simulation module may be selected together with the first simulation module. When simulation module selection information is received from a non-expert user, it may be difficult to select all required simulations. The manager, when a specific simulation module, the first simulation module is selected, may set a second simulation module is linked with the first simulation module even if it is not selected by the user terminal 200. When selecting the first simulation module, the second simulation module is also selected, so that the accuracy and satisfaction of simulation results can be enhanced.

The second simulation module is a simulation module that uses the results of the first simulation module, or may be a simulation module that performs simulation simultaneously with the first simulation. The second simulation module may be a simulation module that uses the simulation performance results of the first simulation module as input when linked with the first simulation module. When it is difficult to provide a user with desired results with only the simulation performance results of the first simulation module requiring additional simulation, the corresponding simulation module can be linked.

Or, the second simulation module may be a simulation module performed simultaneously with the first simulation module. It may be a simulation module that must be provided together with the simulation performance results of the first simulation module, or a simulation module for providing various results to a user.

Linkage of the second simulation module to the first simulation module can be set and managed by a manager with expert knowledge. The simulation module linkage setting information is not fixed and can be set by the manager according to the simulation results to be provided through simulation.

When a simulation module is selected, the processing unit 120 performs simulation using input information. When a simulation module is selected, the simulation is performed using input information, which is information required for the simulation module to perform simulation. That is, simulation is performed using appearance information, physical property information, and analysis condition information included in the input information. At this time, input information or previous input information stored in the storage unit 130 of the simulation providing device 100 can be used. The storage unit 130 may play the role of a library including physical property information or analysis condition information.

When a plurality of simulation modules are selected, input information may be input information of at least one simulation module among the plurality of simulation modules. The input information may be input information for one simulation module among a plurality of simulation modules, or may be common input information for all of the plurality of simulation modules. As shown in FIG. 4, the input information received from the user terminal 200, when it is the first to third input information, the first input information is the input information of the first module, the second input information is the input information of the second module, and the third input information may be common input information of the first module and the second module. Each of simulation modules that receive input information performs simulation, and the simulation performance results are transmitted to the user terminal 200 as output.

The first simulation module and the second simulation module according to the simulation module interconnection information may also be inputted to at least one simulation module. The input information may include at least one among individual input information for the first simulation module, individual input information for the second simulation module, and common input information for the first simulation module and the second simulation module. For example, appearance information may be common input information of the first simulation module and the second simulation module, some of the physical property information is individual input information for the first simulation module, and the remainder of the physical property information may be individual input information for the second simulation module. After selecting a simulation module, required input information is requested from the user terminal 200, or additional input information may be requested. As shown in FIG. 5, the input information is the first to third input information, and the first simulation module is the first module and the second module according to the simulation module linkage, the second simulation module being linked may be a third module. Here, the third module may be a simulation module being selected together according to simulation module linkage information even if the third module is not selected by a user. At this time, the first input information is the input information of the first module, the second input information is the input information of the second module, and the third input information may be the input information of a third module. The third input information may be input information being additionally inputted according to the linkage of the third module. The third module performs simulations by receiving not only the third input information but also the simulation performance results of the first and second modules as an input, and may transmit the performance results to the user terminal 200 as an output. The simulation performance results of the third module may be transmitted to the user terminal 200 as an output together with the simulation performance results of the first module and the second module.

When performing simulation, the processing unit 120 may simplify the appearance information according to the drawing data when the appearance information included in the input information includes drawing data. The drawing data for the corresponding object displays detailed configurations, which may be unrequired or intrusive in performing the simulation. Accordingly, appearance information according to drawing data can be simplified into a form suitable for performing simulation. For example, the appearance information where the border of the substrate is rounded can be simplified into an angular shape. Through this, the appearance information can be simplified with only the width, length, and height of the substrate. The processing unit 120 may perform simulation using appearance information simplified in a form suitable for performing simulation.

When the appearance information included in the input information includes an appearance value, the processing unit 120 may draw the appearance value as a drawing. When a numerical value is inputted as appearance information, the corresponding object can be drawn from the corresponding numerical value. Through this, an image of the corresponding object can be provided to the user terminal 200, and it may be possible to convert it into a form suitable for performing simulations. The processing unit 120 may perform a simulation by drawing the appearance information being inputted as a numerical value. In addition, simulation can be performed by converting the information being inputted into information suitable for performing simulation.

The simulation results of the simulation performed by the processing unit 120 can be transmitted to the user terminal. The simulation performance results may be transmitted to the user terminal 200 through the communication unit 110 or provided to the user through an interface. In addition, the simulation performance results are stored in the storage unit 130 and converted into a database to be transmitted to the user terminal 200 or externally as needed or it may be used to perform other simulations.

The communication unit 110 can transmit and receive data through wired and wireless communication with the user terminal 200 as well as the manager terminal 300. The communication unit 110 may receive at least one among a simulation module program, simulation module linkage setting information, physical property information, parameter information, license, or user authority management information from the manager terminal 300. A manager who wants to provide a simulation providing service can add or delete by uploading the simulation module program to be provided to the simulation providing device by using the manager terminal 300. In addition, in order to provide users with more accurate and diverse simulation results, the simulation module linkage setting information that links between simulation modules can be updated. In addition, physical property information, parameter information, and the like can be created, inputted, and updated required to perform simulation. In addition, information setting the type of input information being requested from the user terminal 200 for each simulation module can be updated. In addition, management information that manages licenses to use simulation modules or user rights to use simulation providing devices module can be updated. Through this, a manager can efficiently manage licenses and also perform maintenance, such as upgrading simulation modules, efficiently.

The storage unit 130 stores at least one among a plurality of simulation modules, simulation module linkage setting information, simulation performance results, appearance information, physical property information, parameter information, license, and user authority management information. The storage unit 130 may store the simulation module in the form of a program or instructions executed by the processing unit 120. The simulation performance results can be saved in various formats, such as text data, graph data, and the like.

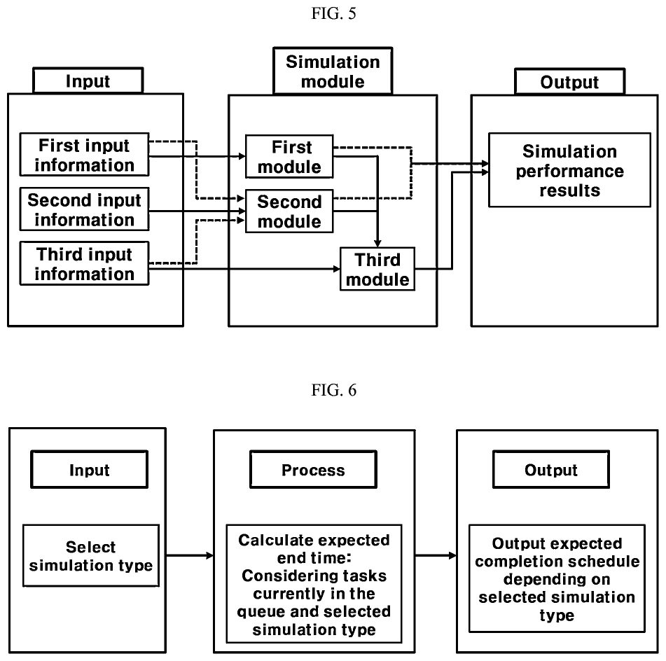

The processing unit 120 may calculate the expected end time of the simulation using the received simulation module selection information and the currently working task. When the processing unit 120 receives a simulation request from the user terminal 200, the processing unit 120 calculates the expected end time of the simulation using the received simulation module selection information and the currently working task. Since there are limits to the available resources of the simulation providing device, the expected end time of the simulation can be calculated according to the currently implemented specification, by using total resources, simulation module selection information, and currently working task. The calculated expected end time can be transmitted to the user terminal 200 to help the user plan scheduling. As shown in FIG. 6, when the simulation type is selected according to the simulation module selection information, by using the tasks currently in the queue (QUE) and the selected simulation type, the expected end time and output the expected end time can be calculated and transmitted to the user terminal 200.

A desired end time (due date) can be inputted from the user terminal 200, and whether the end time can be completed by the desired end time and an expected end time can be calculated and transmitted.

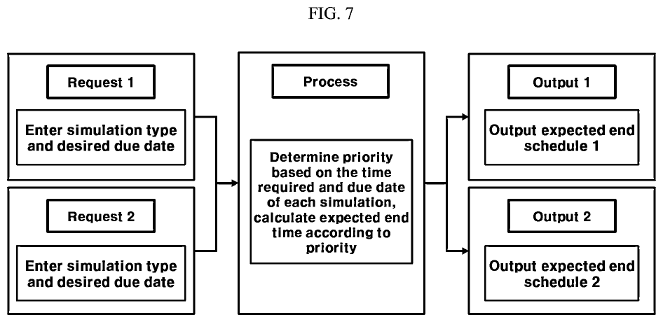

When receiving a plurality of simulation requests from a plurality of user terminals 210 to 230, or receiving multiple simulation requests from one user terminal 220, the work schedule for tasks to perform simulation can be set according to the above plurality of simulation requests according to the priority of allocating resources. As shown in FIG. 3, when receiving a plurality of simulation requests are received from a plurality of user terminals 210 to 230, or when receiving multiple simulation requests from one user terminal 220, and the like, when multiple simulation requests are concentrated at once and simultaneous processing is difficult due to the limitations of the currently available resources of the simulation providing device, it can be processed as FIFO (First In First Out) depending on the simulation request time, or, the task sequence can be efficiently adjusted according to the priority of resource allocation. The priority for allocating resources can be set according to the level of urgency of the task, simulation request time, user authority, type and size of resources required for the simulation module, desired end time, and the like. Or, priorities may be set by the manager. The changed expected end time can be transmitted to the corresponding user terminal 200 when the expected end time changes depending on resource allocation priority. As shown in FIG. 7, when receiving a simulation request, the desired end time can be received as well, the priorities based on the duration and desired end time of each simulation is determined, the expected end time according to the determined priority is calculated, and each expected end time can be outputted and transmitted to each user terminal 200.

The simulation providing device according to an embodiment of the present invention can provide various simulations, as shown in the table below. At this time, examples of input information and corresponding output are as follows.

TABLE 1

| Simulation | Input | Output | Remarks |
|---|---|---|---|
| PS warpage | Width, vertical length, number | Amount of | Enter |
| | of layers, layer height, physical | thermal | parameter using GUI |
| | properties of | deformation | |
| | substrate | | |
| Motor | Rotor/stator spec, current, | Frequency, mode | Enter |
| vibration | physical properties, | shape, vibration | parameter/some 3D |
| noise | bracket/housing 3D CAD file | amount, noise | CAD using GUI |
| PS plating | Width, vertical length, copper | Current density, | Enter parameter |
| | foil ratio, electrical | plating thickness | using GUI |
| | conductivity of panel/strip/unit | | |
| DC-DC | Partial size of DC-DC cover | Temperature | Enter parameter/part |
| electric | (size of width, vertical length, | distribution | of CAD using GUI |
| heating | coolant part), size of pad, | | |
| | device 3D CAD file, thermal | | |
| | conductivity | | |
| CM tray | 3D CAD file, physical | Stress distribution | Enter entire 3D CAD |
| rigidity | properties of the CM tray | | |
| CM tray | 3D CAD file of CM tray, | Tray deformation | Enter entire 3D CAD |
| deflection | physical properties | distribution | |
| amount | | | |

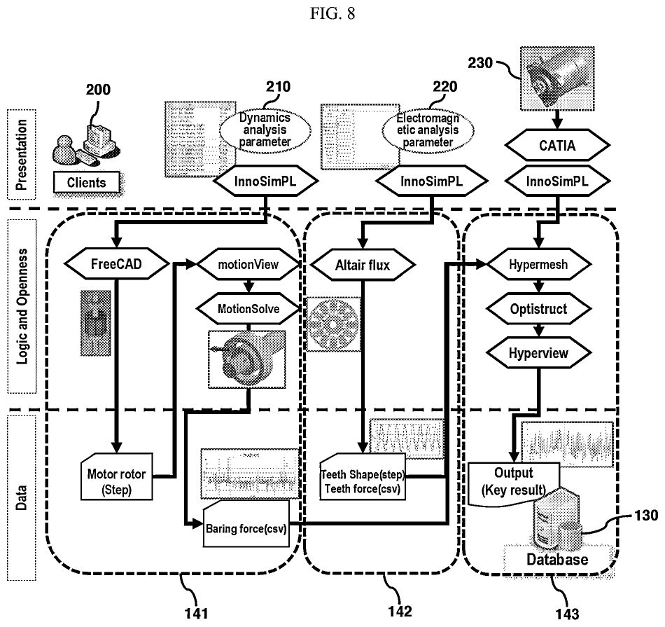

FIG. 8 shows the process of providing simulation for motor vibration noise, when receiving a simulation request for motor vibration noise from the user terminal 200, according to the simulation module selection information of motor vibration noise, The third module 143, which models the results of each simulation module, can be linked and selected, and at the same time the first module 141, which is a dynamic analysis simulation module, and the second module 142, which is an electromagnetic analysis simulation module can be selected. The dynamic analysis parameters of the input information inputted through the user terminal 200 is converted into the motor rotor in a first module to perform dynamic analysis simulation and outputted as a result of bearing force (CSV), and the second module performs simulation using electromagnetic analysis parameters and outputs the results of teeth shape (STEP) and teeth force (CSV). The drawing data 230, which is 3D modeling data as input information, is used to perform simulation for 3D modeling of the third module 143 together with the results of the first module 141 and the second module 142, and is mapped to 3D data and output along with the final simulation results. The final simulation performance results are stored in the storage unit 130, and may be transmitted to the user terminal 200.

The manager can upload the simulation module, and the simulation module can be loaded into InnoSimPL, and load it into InnoSimPL when creating a new physical property. In addition, the linkage combination and relationship of simulation modules can be updated, and when a new simulation module is uploaded, the linkage can be performed accordingly. In addition, when performing license management, accessor or user rights management, can manage simulation modules and InnoSimPL access licenses (maintenance, purchase additional investments, and the like), and update the InnoSimPL version.

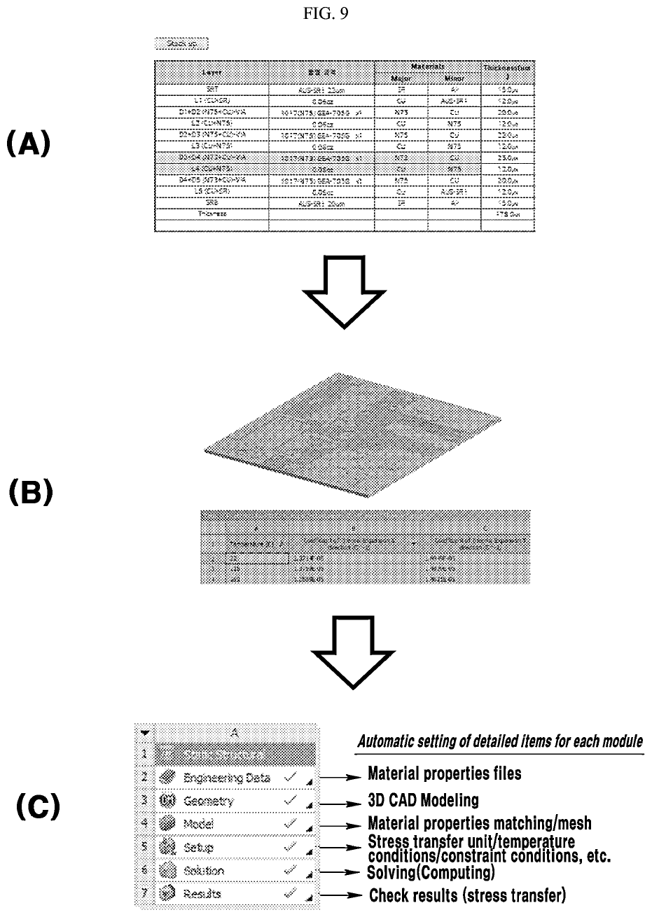

FIG. 9 shows the process of providing simulation for PS (PACKAGE SUBSTRATE) WARPAGE, and upon receiving input information (A), effective physical property simulation and substrate accumulation process simulation are performed through physical property analysis (B). measurement data is Obtained, and after analyzing the obtained data and converting the material properties into input form, an image file is created, effective physical property prediction simulation is performed using material information, and after converting the material property input form, and in conjunction with this, substrate accumulation process simulation (WARPAGE) is performed. The substrate accumulation process simulation repeats the process of 3D modeling, material property setting, meshing, boundary condition setting, unit process simulation, and stress output process according to the accumulation process. Afterwards, the final result can be outputted (C).

In addition, when performing simulations for PS plating, after receiving parameter input and simplifying the model through width, height, and copper foil ratio in the order of panel, strip, and unit, and after reflecting the process environment for each plating tank and setting parameters, by performing electroplating simulation, results can be derived predicting the tendency of plating thickness deviation within the substrate. Simulation of DC-DC electrical heating can derive electrical heating results by performing simulation through 3D modeling, FE meshing, solution setting, heat source setting, and boundary condition setting. Simulation of CM TRAY rigidity/deflection can derive results as to whether design standards are satisfied according to design parameters through layout configuration simulation.

As described above, through the simulation providing device according to the embodiment of the present invention, simulation can be performed when required without the need to separately install a specialized simulation tool, and the required simulation can be performed even without any simulation-related knowledge. Therefore, simulation results can be obtained in a timely manner without having to consider the schedule of a simulation expert. In addition, the licenses required to use the simulation tool can be efficiently managed, and simulation results and physical property information are stored in a database so that they can be easily reused in the future. Furthermore, one simulation module can be used alone, or multiple modules can be used to perform complex simulations by exchanging input and output and interconnecting, and managers can efficiently perform maintenance such as upgrading simulation modules and the like.

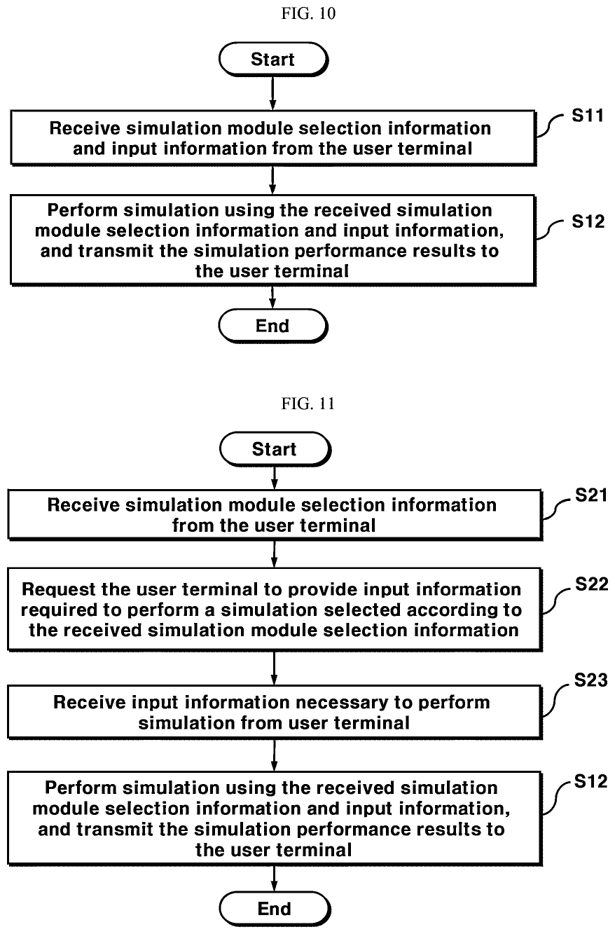

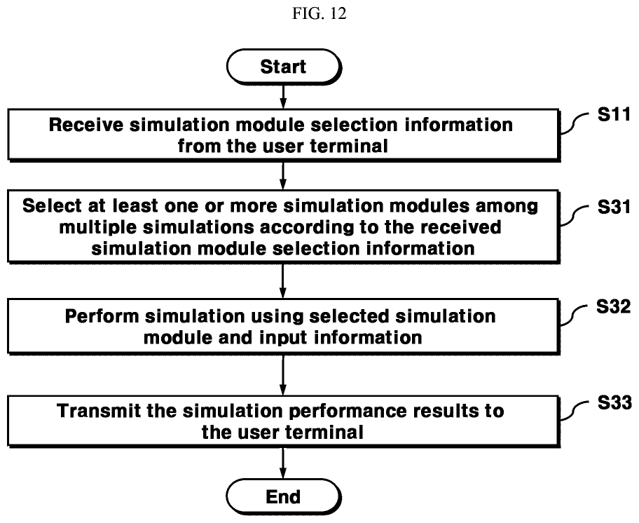

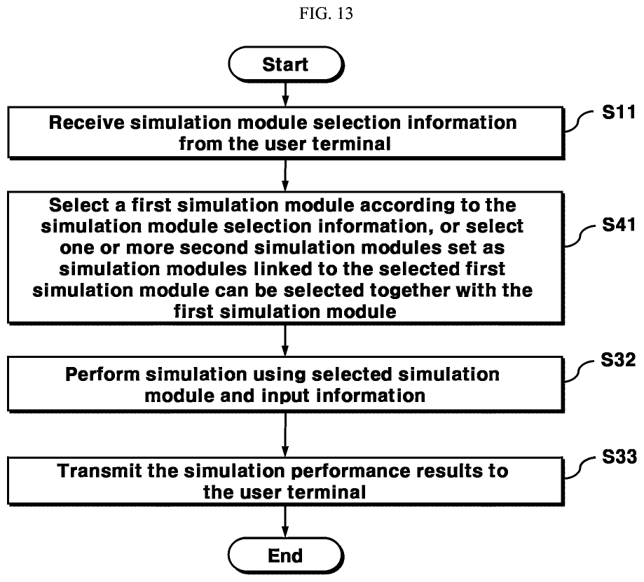

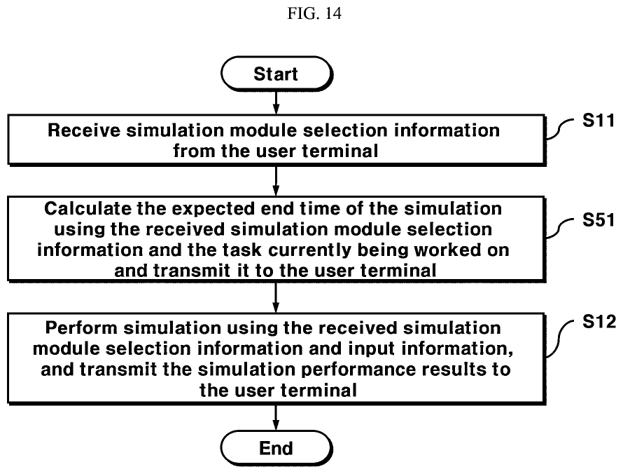

FIG. 10 is a flowchart of a method for providing simulation according to an embodiment of the present invention; and FIGS. 11 to 14 are flowcharts of a method for providing simulation according to an embodiment of the present invention. The detailed description of each step in FIGS. 10 to 14 corresponds to the detailed description of the simulation providing device in FIGS. 1 to 9, and overlapping descriptions will be omitted hereinafter.

In order to provide a simulation to a user, the simulation providing method according to an embodiment of the present invention receives simulation module selection information and input information from the user terminal in step S11, and simulation is performed using the received simulation module selection information and input information in step S12, and the simulation results are transmitted to the user terminal.

Here, the input information may include at least one among appearance information, physical property information, and analysis condition information. The appearance information may include at least one among selection information for selecting one of the appearance dimensions of the corresponding object to be simulated, drawing data, or appearance information stored in a storage unit, The physical property information may include at least one of the physical property data of the corresponding object on which simulation is to be performed, selection information for selecting one of the physical property information stored in the storage unit, or correction information for selecting and modifying one of the physical property information stored in the storage unit. The analysis condition information may include at least one among simulation environment information, boundary conditions, excitation conditions, and parameter data.

Step S11 of receiving the simulation module selection information and input information may be performed through steps S21 to S23. In step S21, the simulation module selection information is received from the user terminal, in step S22, the simulation module selected according to the received simulation module selection information requests the user terminal for input information required to perform the simulation, and in step S23, input information required to perform the simulation can be received from the user terminal. Here, the input information required to perform the simulation may be preset for each simulation module or may be set by a manager.

Step S12 of transmitting the simulation performance results to the user terminal may be performed through steps S31 to S33. In step S31, at least one simulation module is selected from among a plurality of simulations according to the received simulation module selection information, in step S32, a simulation is performed using the selected simulation module and the input information, and in step S33, the simulation performance results can be transmitted to the user terminal.

Step S31 of selecting the simulation module selects a first simulation module according to the simulation module selection information received in step S41, one or more second simulation modules set as simulation modules linked to the selected first simulation module can be selected together with the first simulation module. Here, the second simulation module is a simulation module that uses the results of the first simulation module, or may be a simulation module that performs simulation simultaneously with the first simulation, and the input information may include at least one of individual input information for the first simulation module, individual input information for the second simulation module, and common input information for the first simulation module and the second simulation module.

The step of performing the simulation is when the appearance information included in the input information includes drawing data, the appearance information according to the drawing data is simplified, or when the appearance information included in the above input information includes appearance values, the above external figures can be drawn into drawings.

After step S11 of receiving simulation module selection information and input information from the user terminal, in step S51, the expected end time of the simulation can be calculated using the received simulation module selection information and the task currently being worked on and transmitted to the user terminal. At this time, when receiving multiple simulation requests from multiple user terminals or receiving multiple simulation requests from one user terminal, the work schedule of the task to perform simulation according to the plurality of simulation requests can be set depending on the priority of resource allocation.

In addition, steps of receiving at least one among a simulation module program, simulation module linkage setting information, physical property information, parameter information, license and user rights management information from a manager terminal, and storing the information received from the manager terminal in a storage unit may be included.

Embodiments of the present invention may be implemented in the form of program instructions that can be executed through various computer means and recorded on a computer-readable medium. The computer-readable medium may include program instructions, data files, data structures, and the like, alone or in combination. Program instructions being recorded on the medium may be specially designed and constructed for the present invention or may be known and usable by those skilled in the art of computer software. Examples of computer-readable recording media include magnetic media such as hard disks, floppy disks, and magnetic tapes, optical media such as CD-ROMs and DVDs, magneto-optical media such as floptical disks, and hardware devices such as ROM, RAM, flash memory, and the like specifically configured to store and perform program instructions, In addition, the computer-readable recording medium is distributed over a networked computer system, so that computer-readable code can be stored and executed in a distributed manner. And functional programs, codes, and code segments for implementing the present invention can be easily deduced by programmers in the technical field to which the present invention pertains. Examples of program instructions include machine language code, such as that produced by a compiler, as well as high-level language code that can be executed by a computer using an interpreter, and the like. The hardware devices described above may be configured to operate as one or more software modules to perform the operations of the present invention, and vice versa.

Those skilled in the art to which the present invention pertains will understand that the present invention can be embodied in other specific forms without changing its technical spirit or essential features. Therefore, the embodiments described above should be understood as illustrative in all respects and not limiting. The scope of the present invention is indicated by the claims described below rather than the detailed description previously described, and all changes or modified forms derived from the meaning and scope of the patent claims and their equivalent concepts should be construed as being included in the scope of the present invention.

1. A simulation providing method comprising the steps of:
receiving simulation module selection information and input information from a user terminal; and
performing a simulation using the received simulation module selection information and the input information, and transmitting simulation performance results the to the user terminal,
wherein the input information comprises at least one among appearance information, physical property information, and analysis condition information.

2. The simulation providing method according to claim 1,
wherein the appearance information comprises at least one among selection information for selecting one of appearance information stored in a storage unit, appearance dimensions, or drawing data of an object to be simulated.

3. The simulation providing method according to claim 1,
wherein the physical property information comprises at least one among physical property data of an object to be simulated, selection information for selecting one of physical property information stored in a storage unit, or correction information for selecting and modifying one of physical property information stored in the storage unit.

4. The simulation providing method according to claim 1,
wherein the analysis condition information comprises at least one among simulation environment information, boundary conditions, excitation conditions, and parameter data.

5. The simulation providing method according to claim 1,
wherein the step of receiving the simulation module selection information and the input information comprises the steps of:
receiving the simulation module selection information from the user terminal;
requesting input information required for a simulation module, which is selected according to the received simulation module selection information, to perform simulation from the user terminal; and
receiving input information required to perform simulation from the user terminal.

6. The simulation providing method according to claim 5,
wherein the input information required to perform simulation is preset for each simulation module or is set by a manager.

7. The simulation providing method according to claim 1,
wherein the step of transmitting the simulation performance results to the user terminal comprises the steps of:
selecting at least one simulation module among a plurality of simulations according to the received simulation module selection information;
performing a simulation using the selected simulation module and the input information; and
transmitting the simulation performance results to the user terminal.

8. The simulation providing method according to claim 7,
wherein the step of selecting the simulation module selects a first simulation module according to the received simulation module selection information, or selects one or more second simulation modules set as simulation modules linked to the first simulation module together with the first simulation module.

9. The simulation providing method according to claim 8,
wherein the second simulation module is a simulation module that uses a results of the first simulation module, or a simulation module that performs simulation simultaneously with the first simulation.

10. A simulation providing device comprising:
a communication unit configured to receive simulation module selection information and input information from a user terminal and transmit simulation performance results to the user terminal; and
a processing unit configured to perform simulation using the received simulation module selection information and the input information,
wherein the input information comprises at least one among external information, physical property information, and analysis condition information.

11. The simulation providing method according to claim 8,
wherein the input information comprises at least one among individual input information for the first simulation module, individual input information for the second simulation module, and common input information for the first simulation module and the second simulation module.

12. The simulation providing method according to claim 7,
wherein the step of performing the simulation comprises the steps of:
simplifying, when drawing data are comprised in appearance information comprised in the input information, the appearance information according to the drawing data; or
drawing, when appearance dimensions are comprised in appearance information comprised in the input information, with the appearance dimensions.

13. The simulation providing method according to claim 1,
wherein the expected end time of the simulation is calculated and transmitted to the user terminal by using the received simulation module selection information and currently working task.

14. The simulation providing method according to claim 1,
wherein, when receiving multiple simulation requests from multiple user terminals or receiving multiple simulation requests from one user terminal, a work schedule of task to perform simulation according to the plurality of simulation requests is set depending on a priority of resource allocation.

15. The simulation providing method according to claim 1, comprising the steps of:
receiving at least one among a simulation module program, simulation module linkage setting information, physical property information, parameter information, license, and user authority management information from a manager terminal; and
storing information received from the manager terminal in a storage unit.

16. The simulation providing device according to claim 10,
wherein the communication unit receives at least one among a simulation module program, simulation module linkage setting information, physical property information, parameter information, license, and user authority management information from a manager terminal.

17. The simulation providing device according to claim 10, comprising:
a storage unit configured to store a plurality of simulation modules, simulation module linkage setting information, simulation performance results, appearance information, physical property information, parameter information, license, or user authority management information.

18. The simulation providing device according to claim 10,
wherein the processing unit selects at least one simulation module among a plurality of simulations according to the received simulation module selection information, performs a simulation using the selected simulation module and the input information, and
the processing unit selects a first simulation module according to the received simulation module selection information in selecting the simulation module or selects one or more second simulation modules set as a simulation module linked to the selected first simulation module together with the first simulation module.

19. The simulation providing device according to claim 18,
wherein the second simulation module is a simulation module that uses the results of the first simulation module, or a simulation module that performs simulation simultaneously with the first simulation, and
wherein the input information comprises at least one among individual input information for the first simulation module, individual input information for the second simulation module, and common input information for the first simulation module and the second simulation module.

20. The simulation providing device according to claim 10,
wherein the communication unit comprises an interface that receives the simulation module selection information or the input information, or outputs the simulation performance results.
